(19) United States
(12) Patent Application Publication
(10) Pub. No.: US 2025/0390457 A1
(43) Pub. Date: Dec. 25, 2025

(54) BUS BRIDGE, CHIP, AND LiDAR

(71) Applicant: SUTENG INNOVATION TECHNOLOGY CO., LTD., Shenzhen (CN)

(72) Inventors: Yumin LIAO, Shenzhen (CN); Yuqi LIU, Shenzhen (CN); Yueqing YANG, Shenzhen (CN)

(73) Assignee: SUTENG INNOVATION TECHNOLOGY CO., LTD., Shenzhen (CN)

(21) Appl. No.: 19/239,900

(22) Filed: Jun. 16, 2025

(30) Foreign Application Priority Data
Jun. 25, 2024 (CN) 202410824941.0

(51) Int. Cl. G06F 13/40

(52) U.S. Cl. CPC G06F 13/4027; G06F 2213/40

(57) ABSTRACT

A bus bridge, a chip, and a LiDAR are provided. The bus bridge includes a reception data verification module configured to determine a reception verification result of received data based on received data verification information carried by the received data; a data protocol conversion module configured to convert the received data conforming to an initial data transmission specification into output data conforming to a target data transmission specification; and an output data encoding module configured to encode at least a portion of the output data to generate corresponding output data verification information, thereby enabling the output data to carry the corresponding output data verification information.

### CROSS-REFERENCE TO RELATED APPLICATION

The present application claims the benefit of priority to Chinese Patent Application No. 202410824941.0, filed on Jun. 25, 2024, which is hereby incorporated by reference in its entirety.

### TECHNICAL FIELD

The present application pertains to the field of LiDAR technology and particularly relates to a bus bridge, a chip, and a LiDAR.

### BACKGROUND

In fields such as autonomous driving and intelligent transportation, enabling vehicles or other carriers to quickly and accurately perceive road and environmental conditions is central to achieving automated operation.

Typically, vehicles and other carriers rely on one or multiple onboard sensor devices to perceive road and environmental conditions. Among various sensor devices, LiDAR (Light Detection and Ranging) is the most critical equipment. The position/size/motion information of traffic participants perceived and collected by LiDAR constitutes the most vital data required by decision-making systems.

The main control chip inside a LiDAR is its core component, responsible for the collection, processing, and transmission of all LiDAR information. As a complex system including numerous components, the effectiveness and reliability of measures ensuring the accuracy and integrity of data transmission within the main control chip still require improvement.

### SUMMARY

Embodiments of the present application provide a bus bridge, a chip, and a LiDAR.

In a first aspect, the embodiments of the present application provide the following technical solution: a bus bridge. The bus bridge includes: a received data verification module configured to determine a reception verification result of received data based on received data verification information carried by the received data; a data protocol conversion module configured to convert the received data conforming to an initial data transmission specification into output data conforming to a target data transmission specification; and an output data encoding module configured to encode at least a portion of the output data to generate corresponding output data verification information, thereby enabling the output data to carry the corresponding output data verification information.

In a second aspect, the embodiments of the present application provide the following technical solution: a chip. The chip includes: at least one first device, each of the first devices being connected to a first bus; at least one second device, each of the second devices being connected to a second bus; and the aforementioned bus bridge, which is bridged between the first bus and the second bus to establish a communication connection between the first device and the second device.

In a third aspect, the embodiments of the present application provide the following technical solution: a LiDAR. The LiDAR includes the aforementioned chip.

At least one advantageous aspect of the bus bridge provided in the embodiments of the present application is as follows: by incorporating additional data verification mechanisms during the process of data transmission specification conversion, the bus bridge is capable of enhancing the accuracy and integrity of data transmission. Errors that occurs during data transmission may be promptly detected and flagged, thereby improving the reliability of data transmission and preventing severe and otherwise unpredictable safety incidents.

### BRIEF DESCRIPTION OF DRAWINGS

FIG. 1 is a schematic diagram of a chip according to an embodiment of the present application.

FIG. 2A is a schematic diagram of a first data verification mechanism according to an embodiment of the present application.

FIG. 2B is a schematic diagram of a second data verification mechanism according to an embodiment of the present application.

FIG. 3A is a schematic diagram of a bus bridge according to an embodiment of the present application.

FIG. 3B is a schematic diagram of a bus bridge according to an embodiment of the present application.

FIG. 4 is a schematic diagram of a bus bridge according to an embodiment of the present application.

FIG. 5 is a schematic diagram of a bus bridge according to an embodiment of the present application.

FIG. 6A is a schematic diagram of a first buffer verification module according to an embodiment of the present application.

FIG. 6B is a schematic diagram of a second buffer verification module according to an embodiment of the present application.

FIG. 7 is a schematic diagram of a bus bridge according to an embodiment of the present application.

FIG. 8A is a schematic diagram of a bus bridge according to an embodiment of the present application.

FIG. 8B is a schematic diagram of a bus bridge according to an embodiment of the present application.

FIG. 9A is a schematic diagram of a bus bridge according to an embodiment of the present application.

FIG. 9B is a schematic diagram of a bus bridge according to an embodiment of the present application.

### DETAILED DESCRIPTION

To facilitate understanding of the present application, the following provides a detailed explanation of the present application in conjunction with the drawings.

It should be noted that when an element is referred to as being “mounted on” another element, it may be directly on the other element or intervening elements may also be present. When an element is considered to be “connected” to another element, it may be directly connected to the other element or intervening elements may simultaneously exist. It may also mean that the two elements are interactively connected through signals. When an element is considered to be “coupled” or “connected” to another element, it may be directly coupled to the other element or intervening elements may simultaneously exist. It may also mean that the two elements interact through signals.

The term “bus bridging” refers to the process of transferring data between two buses that use different data transmission protocols. It may be implemented by one or more hardware and/or software components.

The term “chip” refers to an integrated circuit, small electronic device, or component made of semiconductor materials (e.g., silicon) that has one or more electronic functions and is capable of executing one or more specific electronic tasks.

The term “component” refers to an independent part of a system or device with a specific function. Each component contains all the elements and logic required to fulfill its function and can collaborate with other components to form a complex system. A component may exist in the form of software, hardware, or a combination of both.

The term “data verification mechanism” refers to a method for detecting whether errors occur during data transmission and correcting errors that arise during data transmission. The term “verification” refers to the process of validating the correctness and integrity of data. Verification may include multiple progressive steps such as error detection, error localization, and/or error correction, providing corresponding results for each step.

The term “interrupt” refers to a mechanism in computer systems for handling asynchronous events. By generating an interrupt, a processing core can suspend its current execution flow, promptly respond to and handle external or internal events, and then resume the original task.

Unless otherwise defined, all technical and scientific terms used herein have the same meanings as commonly understood by those skilled in the technical field of the present application. The terminology used in the description of the present application is for the purpose of describing specific embodiments and is not intended to limit the application. The terms “and/or” and “and/or” used herein include any and all combinations of one or more relevant listed items.

Furthermore, the technical features involved in the present application described below may be combined with each other as long as they do not conflict.

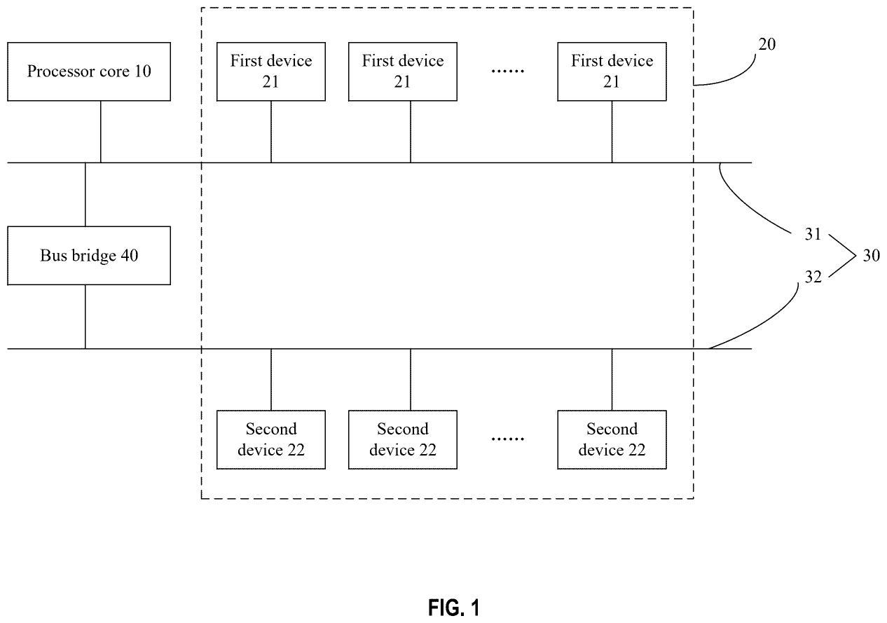

FIG. 1 illustrates an application scenario of bus bridging in the present application, exemplarily showing the use of bus bridging in a chip. As shown in FIG. 1, chip 1 may generally include the following functional modules: a processor core 10, multiple functional devices 20, a bus 30, and a bus bridge 40.

The processor core 10 refers to an independent processing unit within the chip responsible for executing program instructions, processing data, controlling data flow, and performing one or more logical operations. It can complete operations such as fetching, decoding, executing instruction data, and storing results. Illustratively, FIG. 1 shows only a configuration with one processor core 10. Alternatively, the chip may contain two or more processor cores to address and meet different usage requirements.

The functional devices 20, relative to the aforementioned processor core, do not directly participate in the basic instruction execution flow of the processor core but are other devices used to assist chip operation or extend chip functionality.

The bus 30 is a communication system used to connect the processor core and various functional devices within the chip, enabling bidirectional/unidirectional data transmission between them.

This communication system can be considered as including physical-layer connection lines and corresponding data transmission protocols. The physical-layer connection lines provide the transmission medium, while the data transmission protocols define the rules for data flow on these physical-layer connection lines.

Referring further to FIG. 1, based on different requirements for data transmission performance, the functional devices 20 within the chip can be categorized into first devices 21 and second devices 22.

In an embodiment, FIG. 1 shows a scenario where each first device 21 is a high-demand device requiring high-speed data transmission, and each second device 22 is a low-demand device. In some embodiments, depending on actual needs, each first device 21 may also be designated as a high-demand device and each second device 22 as a low-demand device.

In the present application, “high-demand device” and “low-demand device” are relative technical concepts. A high-demand device represents functional equipment that, compared to low-demand devices, requires higher data throughput and must satisfy high-speed data transmission, and vice versa.

For example, high-demand devices include but are not limited to: RAM controllers, DMA controllers, and graphics processing units (GPUs). Low-demand devices include but are not limited to: serial communication interfaces (UARTs), real-time clocks (RTCs), input/output ports (GPIOs), and power management controllers. It is understood that the processor core 10 of the chip is also a high-demand device.

Correspondingly, to meet the data transmission performance requirements of different functional devices, the bus 30 also includes at least two different types, suitable for high-speed and low-speed data transmission scenarios, respectively.

In an embodiment, FIG. 1 shows different types of first bus 31 and second bus 32.

Among them, the first bus 31 is a high-performance bus capable of supporting high data throughput with low latency and high bandwidth. Both the first devices 21 and the processor core 10 are connected via the first bus 31, forming a communication system to enable data interaction between them.

The second bus 32, relative to the first bus 31, is a simpler bus that does not support high-speed data transmission. Multiple second devices 22 are connected via the second bus 32, forming another communication system to enable data interaction among them.

Due to its simplicity in design, the second bus 32 may offer advantages such as reduced power consumption, which aligns with the practical usage requirements of the second devices 22.

Referring further to FIG. 1, when a chip contains at least two types of buses (e.g., the first bus 31 and the second bus 32 as shown in FIG. 1), an additional bus bridge 40 may be used to facilitate the data transfer between different buses (e.g., data transfer between the second devices 22 and the processor core 10).

The “bus bridge” refers to a device capable of implementing bus bridging functionality. For example, command data sent by the processor core 10 can be transmitted to the bus bridge 40 via the first bus 31. After the bus bridge 40 converts the command data into output data compliant with the data transmission protocol of the second bus 32, it is delivered to the corresponding second devices 22 via the second bus 32. Alternatively, feedback data from the second devices 22 can be transmitted to the bus bridge 40 via the second bus 32. After the bus bridge 40 converts the feedback data into output data compliant with the data transmission protocol of the first bus 31, it is delivered to the processor core 10 via the first bus 31.

It was found that the introduction of a bus bridge may impose unintended negative impacts on data transmission. For example, ensuring the accuracy and reliability of data transmission during the bus bridging process across two different communication systems becomes challenging.

Such negative impacts may be fatal or severe in high-standard application scenarios that demand high accuracy and reliability in data transmission. For instance, in LiDAR systems that provide detection data for autonomous vehicle driving, if data transmission errors occur during the normal operation of the LiDAR and not promptly detected or corrected, may lead to severe consequences.

Accordingly, additional data verification mechanisms may be appropriately integrated into the bus bridge to more effectively ensure the accuracy and reliability of data transmission. This significantly enhances the performance of the chip and better meets the requirements of high-standard application scenarios.

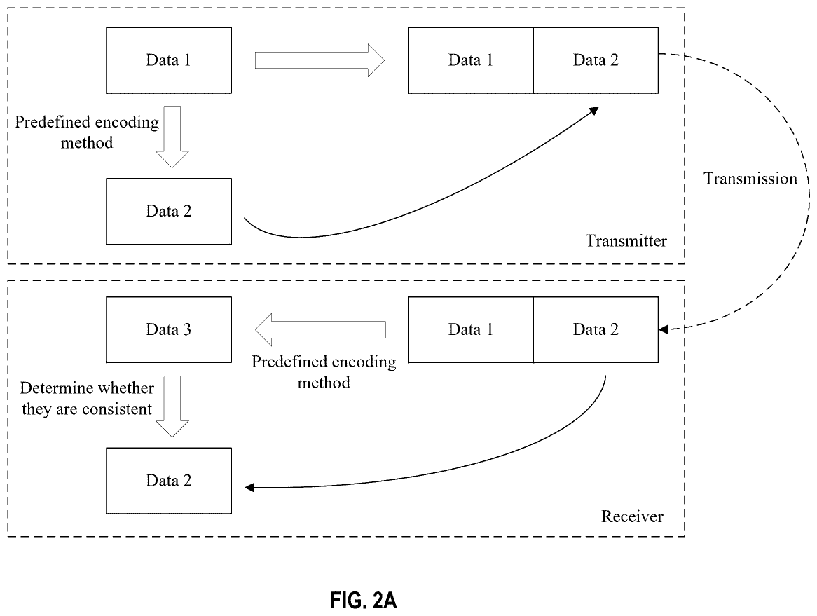

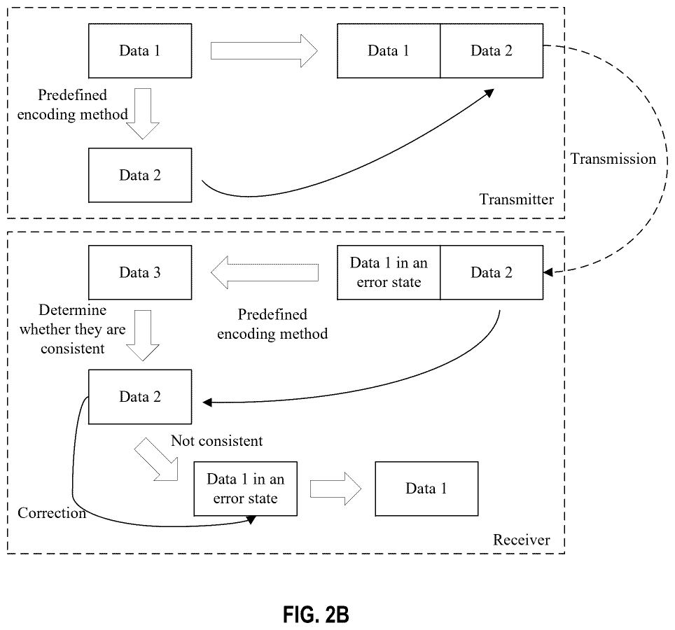

To illustrate the inventive concept of the present application, the specific implementation process and verification principles of the data verification mechanism are detailed below in conjunction with the schematic diagram shown in FIG. 2A.

The data verification mechanism primarily involves coordinated data encoding and decoding. As shown in FIG. 2A, data encoding may be performed at the transmitter (Tx). Before the original data (data1) is transmitted, the transmitter Tx can calculate the original data using a predefined encoding method to obtain a corresponding calculation result (data2), which is then transmitted alongside the original data to the receiver (Rx).

In this context, “corresponding” defines the relevance between two data entities. That is, the corresponding calculation result and the original data share a mathematical computational relationship.

Referring further to FIG. 2A, data decoding may be performed at the receiver (Rx). After the original data is transmitted to the receiver Rx, the receiver Rx can apply the same encoding method used by the transmitter Tx to calculate the original data (data1), obtaining another calculation result (data3).

Based on the following premise: identical data should yield consistent calculation results when subjected to the same encoding calculation.

Accordingly, the receiver Rx can compare its own calculated result (data3) with the calculation result (data2) carried by the original data to determine whether they match. If the two results are consistent, it can be concluded that no errors occurred during the transmission of the original data. The original data received by the receiver Rx is correct and complete, and vice versa.

Based on error detection, more complex mathematical operations may further be employed for encoding (i.e., higher computational complexity) to generate calculation results with greater data information volume, thereby providing sufficient additional information to the receiver for error localization and/or error correction.

The “error localization” refers to identifying erroneous information in the original data. “Error correction” refers to correcting erroneous information in the original data to restore it to the correct state.

For example, as shown in FIG. 2B, when selecting a more complex data computation method, the calculation result (data2) obtained after encoding the original data (data1) at the transmitter (Tx) contains significant redundant information.

Thus, in addition to comparing the calculation result (data3) with the result (data2) carried by the original data to determine whether errors occurred during the transmission of data1, the receiver (Rx) can also utilize the redundant information in data2 to locate and correct errors in the original datal when errors are confirmed, restoring it to the correct data.

In the present application, the term “first data verification mechanism” is used to describe data verification mechanisms that employ encoding methods without error correction capabilities. Exemplarily, the first data verification mechanisms include but are not limited to: data verification based on parity check algorithms, cyclic redundancy check (CRC) codes, and Hamming codes.

Additionally, the term “second data verification mechanism” is used to describe data verification mechanisms that employ encoding methods with error correction capabilities. Exemplarily, the second data verification mechanisms include but are not limited to: data verification based on error-correcting codes.

It should be noted that the extent of error correction provided by the second data verification mechanism is limited. Possessing error correction capability does not imply that the mechanism can complete error correction tasks under all circumstances. For example, in cases where the original data suffers severe errors or significant data loss, error correction may fail even with highly complex mathematical operations.

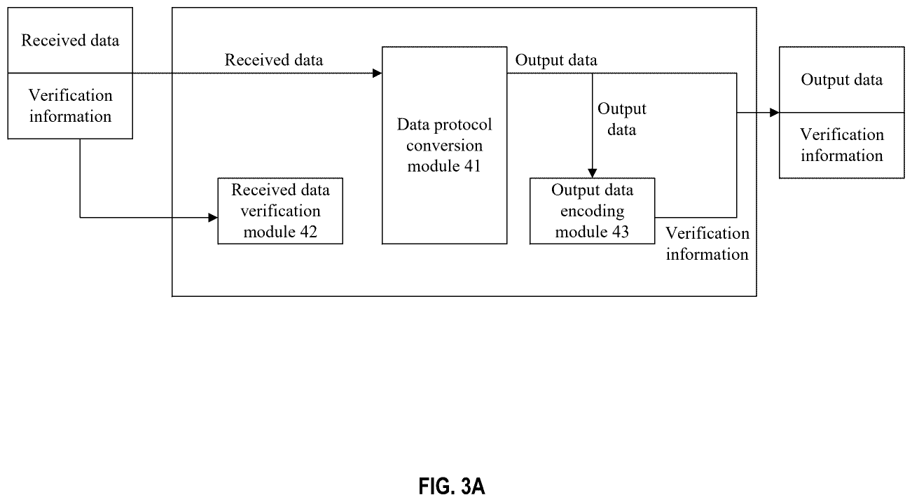

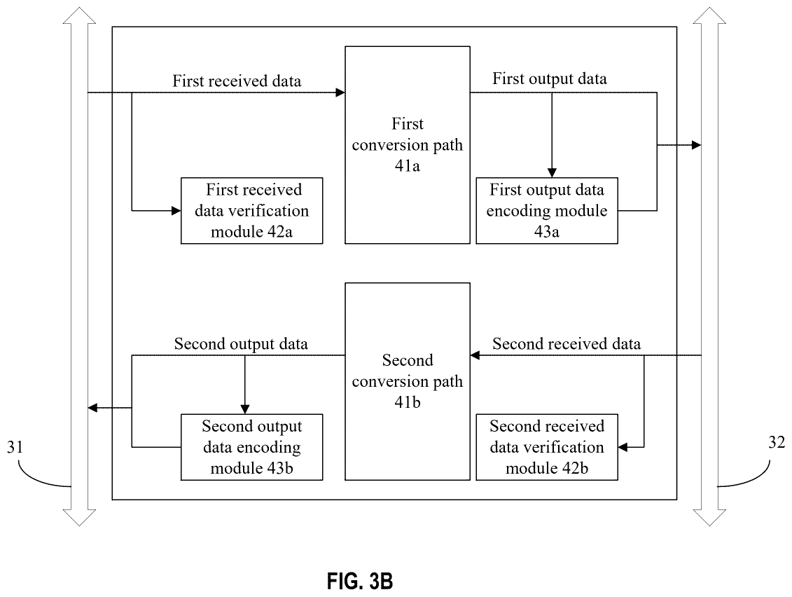

FIG. 3A illustrates a bus bridge augmented with an additional data verification mechanism. The composition of this bus bridge is described in detail below with reference to FIG. 3A.

For simplicity, the data received by the bus bridge before protocol conversion is referred to as “received data,” while the data obtained after protocol conversion is termed “output data.”

It should be clarified that “received data” and “output data” are used solely to distinguish the direction of data flow and impose no limitations on the specific form, format, or content of the data.

As shown in FIG. 3A, the bus bridge 40 may include: a data protocol conversion module 41, a received data verification module 42, and an output data encoding module 43.

The data protocol conversion module 41 is a component responsible for converting data transmission protocols. It transforms received data compliant with an initial protocol into output data compliant with a target protocol, enabling data transfer between different communication systems.

Exemplarily, in the application scenario shown in FIG. 1, to facilitate data transfer between two buses, the data protocol conversion module 41 supports bidirectional conversion. As shown in FIG. 3B, it may include a first conversion path 41a that converts first received data from the first bus 31 into first output data compliant with the protocol of the second bus 32, and a second conversion path 41b that converts second received data from the second bus 32 into second output data compliant with the protocol of the first bus 31.

The received data verification module 42 is a component related to data verification functionality. Positioned upstream of the data protocol conversion module 41, it verifies the received data based on its embedded verification information, thereby determining the verification result (e.g., whether errors occurred during bus transmission).

The output data encoding module 43 is a component related to verification information generation. Positioned downstream of the data protocol conversion module 41, it encodes the output data generated by the conversion module to produce corresponding verification information, ensuring that the bus bridge's output data also carries verification details. In an embodiment, the output data encoding module 43 includes a first output data encoding module 43a and a second output data encoding module 43b.

Taking the scenario in FIG. 1 as an example, when the data verification mechanism is implemented, as shown in FIG. 3B, data transmitted over the first bus 31 and the second bus 32 both carry verification information. Whether the bus bridge receives first received data from the first bus or second received data from the second bus, the first received data verification module 42a and the second received data verification module 42b can verify the data using their respective verification information, ensuring the correctness and integrity of data during transmission on either bus.

In some embodiments, to achieve data transmission speed matching and integration, the bus bridge may also incorporate data buffering during protocol conversion. In the present application, the term “data buffer unit” refers to a functional unit implementing data buffering. Through predefined data management mechanisms, it temporarily stores received data by controlling the orderly entry and exit of each data segment into and out of the buffer.

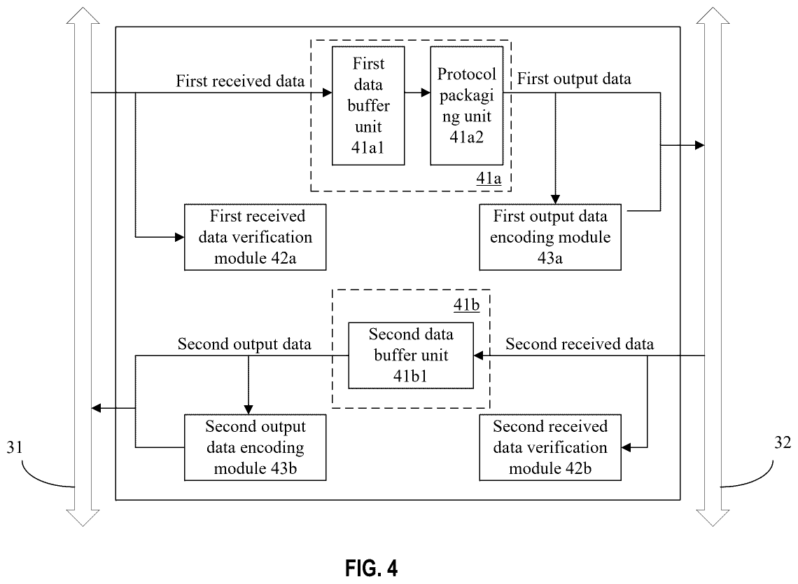

The additional data buffering functionality implemented in the bus bridge can achieve effects such as data transmission speed matching, support for asynchronous operations, and reduction of latency and irregularities during data transfer, thereby significantly enhancing the reliability and performance of the bus bridge. FIG. 4 is a schematic diagram of the bus bridge provided in the present application, exemplarily illustrating the inclusion of data buffer units in both conversion paths of the bus bridge. As shown in FIG. 4, differing from the bus bridge in FIG. 3B, the first conversion path 41a includes: a first data buffer unit 41a1 and a protocol packaging unit 41a2, responsible for data buffering and data encapsulation, respectively. The second conversion path 41b includes: a second data buffer unit 41b1 for data buffering.

The first data buffer unit 41a1 and the second data buffer unit 41b1 are components providing storage space of appropriate sizes. By temporarily storing one or multiple received data entries, they achieve data buffering. Both the first data buffer unit 41a1 and the second data buffer unit 41b1 can employ a predefined data management mechanism to control the orderly entry and exit of each received data entry into and out of the buffer, achieving the desired buffering effect.

For example, the predefined data management mechanism includes rules and standards defining how data enters and exits the buffer. For example, the “First-In, First-Out” (FIFO) rule may be selected as the data management mechanism.

Taking the first data buffer unit 41a1 as an example, it can determine the exit order of each received data entry based on the order in which they enter the first data buffer unit 41a1, ensuring that the sequence of data entering the buffer matches the sequence of data exiting it.

The protocol packaging unit 41a2 is a component positioned downstream of the first data buffer unit 41a1. It receives the first received data exiting the first data buffer unit 41a1 and performs one or more data packaging processes according to the data transmission protocol of the second bus, generating corresponding first output data.

In the present application, “data encapsulation” refers to the process of packaging data into formats compliant with specific communication protocols. Data encapsulation may include but is not limited to: adding protocol headers/trailers, aggregating/disassembling data, or other processing to ensure correct transmission and parsing of data across networks or bus systems. The specific encapsulation methods are not limited here, as long as they ensure the integrity and correctness of data during bus transmission.

It should be noted that the inclusion of the protocol packaging unit 41a2 is not mandatory. Its implementation depends on specific application scenarios and data transmission requirements, and it may be selectively added to the conversion path.

For example, during conversion from an Advanced High-performance Bus (AHB) to an Advanced Peripheral Bus (APB), complex AHB signals must be converted into simpler APB signals. Here, the protocol packaging unit is required to handle timing adjustments, control signal conversions, address and data alignment, and other encapsulation operations to ensure correct data transmission over APB.

Conversely, during conversion from APB to AHB, since APB's data transmission mode is simple, AHB can directly receive and process APB data without additional encapsulation. Thus, no protocol packaging unit is needed in such a conversion path.

Although FIG. 4 exemplarily shows a protocol packaging unit 41a2 in the first conversion path 41a, no such unit is in the second conversion path 41b.

However, according to the first bus and the second bus of a specific application, the protocol package unit can also be set in the first conversion path 41a and the second conversion path 41b respectively, or the protocol package unit 41a2 is not set in the first conversion path 41a and the second conversion path 41b.

During the process of data entering or exiting the data buffer units, errors may still occur. To ensure the accuracy and reliability of data during buffering, additional data verification mechanisms can be applied to the buffering process. In the present application, the data verification mechanism for buffering may be implemented through coordinated buffer encoding and buffer verification modules. The buffer encoding module encodes received data before it enters the buffer to generate corresponding buffer verification information. The buffer verification module then determines the verification results of the received data after it exits the buffer based on this information.

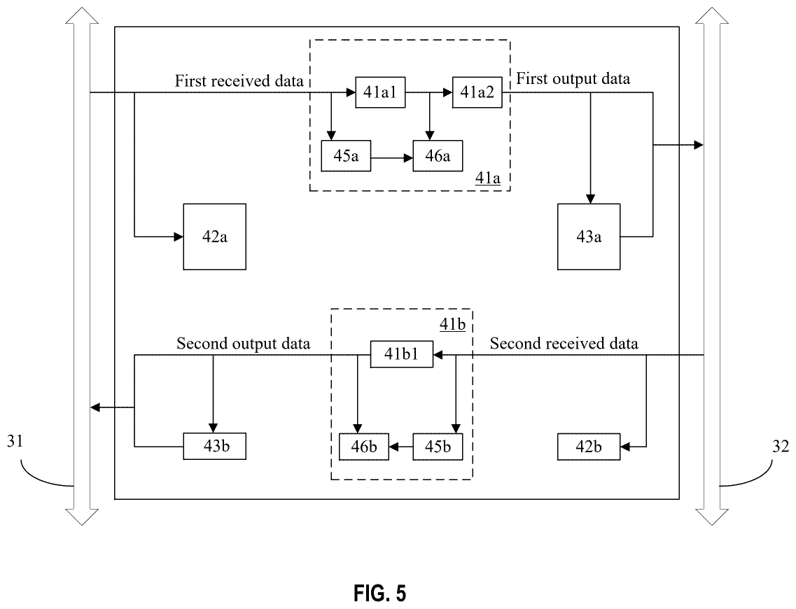

FIG. 5 is a schematic diagram of the bus bridge provided in the present application, exemplarily illustrating the inclusion of buffer encoding modules and buffer verification modules in both conversion paths of the bus bridge. As shown in FIG. 5, differing from the bus bridge in FIG. 4, the first conversion path 41a of this bus bridge further includes a first buffer encoding module 45a and a first buffer verification module 46a. Correspondingly, the second conversion path 41b includes a second buffer encoding module 45b and a second buffer verification module 46b.

The first buffer encoding module 45a and the second buffer encoding module 45b are components designed to perform data encoding, generating verification information corresponding to buffered data. The distinction between them lies in the data objects they encode. The first buffer encoding module 45a encodes the first received data before it enters the first data buffer unit 41a1, producing corresponding first verification information, whereas the second buffer encoding module 45b encodes the second received data before it enters the second data buffer unit 41b1, generating corresponding second verification information.

The first buffer verification module 46a and the second buffer verification module 46b are components dedicated to performing data decoding. Similarly, their primary distinction lies in the data objects they verify. The first buffer verification module 46a determines the verification result of the first received data (hereafter referred to as the first buffered data) after it exits the first data buffer unit 41a1 based on the first verification information. Conversely, the second buffer verification module 46b determines the verification result of the second received data (hereafter referred to as the second buffered data) after it exits the second data buffer unit 41b1 based on the second verification information.

Through the coordinated operation of the buffer encoding modules and buffer verification modules, data verification during the entry/exit of data into/from the buffer units is achieved, ensuring the accuracy and reliability of the data transmission process.

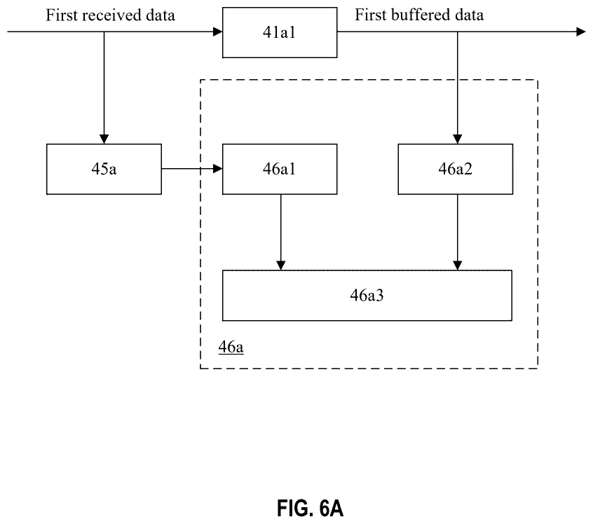

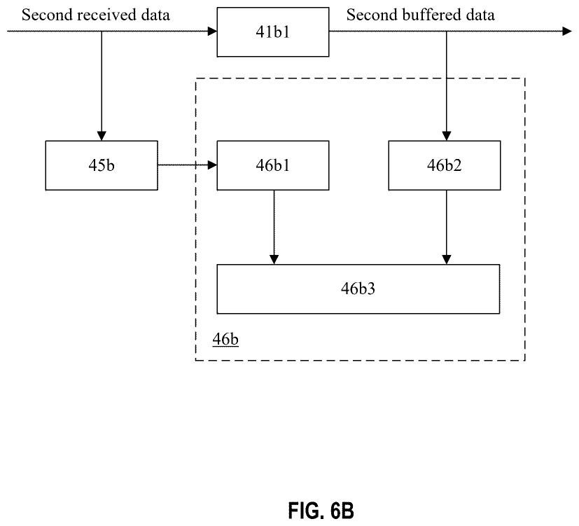

For example, as shown in FIG. 6A, the first buffer verification module 46a may include: a first verification information buffer unit 46a1, a first verification information encoder 46a2, and a first verification information comparator 46a3.

The first verification information buffer unit 46a1 is a component that implements data buffering functionality. It includes a storage area to temporarily store the first verification information generated by the first buffer encoding module 45a, enabling buffering of the first verification information.

The first verification information encoder 46a2 is a component that encodes the first buffered data to produce a first encoded result. In some embodiments, the encoding method used by the first verification information encoder 46a2 is identical to that of the first buffer encoding module 45a. This ensures that when the first received data and the first buffered data are consistent, the first encoded result from the encoder 46a2 matches the first verification information from the encoding module 45a.

The first verification information comparator 46a3 is a component that compares the first verification information exiting the first verification information buffer unit 46a1 with the first encoded result. It outputs a determination of whether the two are consistent, thereby identifying whether errors occurred in the first received data during its entry, retention, or exit from the first data buffer unit 41a1 (i.e., whether the first received data and the first buffered data remain unchanged).

Similarly, as shown in FIG. 6B, the second buffer verification module 46b may include: a second verification information buffer unit 46b1, a second verification information encoder 46b2, and a second verification information comparator 46b3.

The second verification information buffer unit 46b1 controls the orderly entry and exit of each second verification information generated by the second buffer encoding module 45b into and out of the second verification information buffer unit 46b1 according to the predefined data management mechanism, thereby fulfilling the role of data buffering.

The second verification information encoder 46b2 employs the same encoding method as the second buffer encoding module 45b to encode the second buffered data exiting the second data buffer unit 41b1, generating a corresponding second encoded result.

The second verification information comparator 46b3 compares the second verification information exiting the second verification information buffer unit 46b1 with the second encoded result. Based on whether the two are consistent, it determines whether errors occurred in the second received data during its entry, retention, or exit from the second data buffer unit.

In addition to performing data verification during bus transmission, the bus bridge provided in the present application further implements data verification during the buffering process. Through this dual-verification approach, the correctness and integrity of data during the conversion process within the bus bridge are effectively ensured.

As introduced earlier in the data verification mechanisms, the encoding method selected for data verification significantly impacts reliability and computational complexity. More complex encoding methods exhibit higher computational complexity and generate more verification information, yet offer greater reliability and error correction capabilities. Simpler encoding methods, conversely, involve lower computational overhead and less verification information but compromise reliability and lack error correction functionality.

In some embodiments, to balance reliability and computational complexity, the bus bridge may integrate the first and second data verification mechanisms. For example, it applies the more complex second data verification mechanism to critical portions of the data while using the simpler first data verification mechanism for the remaining data.

For simplicity, the portion of received data subject to the first data verification mechanism is termed “first-type data,” while the portion subject to the second data verification mechanism is termed “second-type data.”

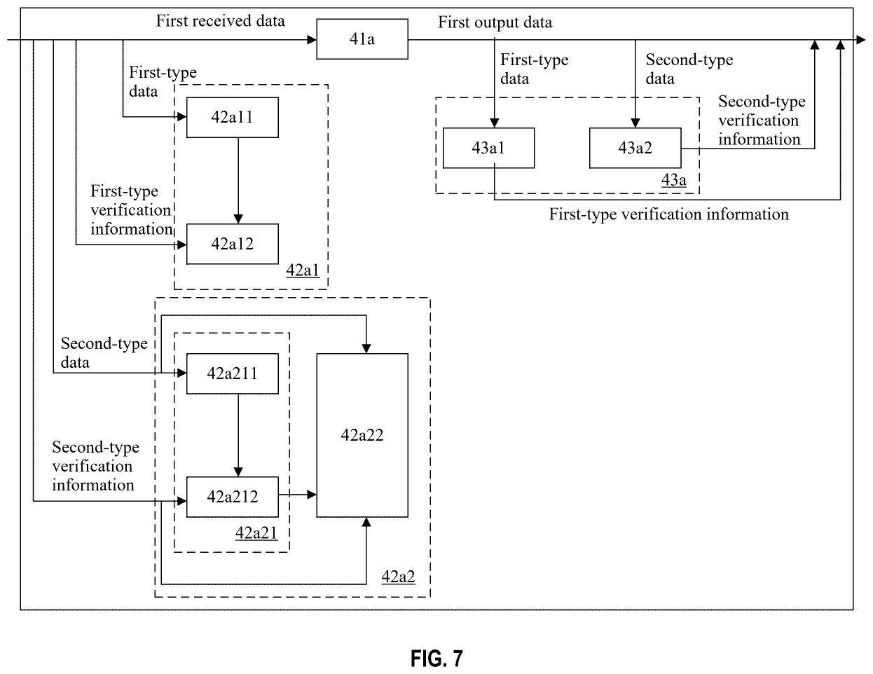

FIG. 7 illustrates a bus bridge integrating both the first and second data verification mechanisms. FIG. 7 showcases the first conversion path. However, those skilled in the art will understand that the integration approach of the first and second data verification mechanisms can also be applied to the second conversion path or other protocol conversion components with similar characteristics, not limited to the example in FIG. 7.

Taking the first received data verification module and the first output data encoding module in FIG. 7 as examples, the specific implementation of integrating the two verification mechanisms is detailed below. As shown in FIG. 7, the first received data verification module 42a may include: a first-type verification unit 42a1 and a second-type verification subunit 42a2.

The first-type verification unit 42a1 is a component responsible for verifying first-type data. It performs error detection on the first-type data using first-type verification information, determines whether errors exist, and outputs corresponding verification results. In some embodiments, the verification information carried by the received data is also categorized into two types: “first-type verification information” for the first data verification mechanism and “second-type verification information” for the second data verification mechanism.

The second-type verification subunit 42a2 is a component that verifies and corrects second-type data within the received data. Leveraging the second-type verification information, it performs both error detection and error correction on the second-type data.

For example, the second-type verification subunit 42a2 can be broadly divided into: an error detection subunit 42a21 for error detection and an error correction subunit 42a22 for error correction when errors are detected.

The error correction capability of the error correction subunit 42a22 has inherent limitations. If errors in the second-type data exceed manageable thresholds, the error correction subunit 42a22 may fail to correct them.

Referencing FIG. 7, to align with the dual data verification mechanisms described above, the first output data encoding module 43a also includes: a first-type encoding unit 43a1 and a second-type encoding unit 43a2.

The first-type encoding unit 43a1 is a component that applies a predefined first-type encoding to the first-type data in the first output data, generating corresponding first-type output data verification information. In this embodiment, “first-type encoding” refers to the encoding method used by the first data verification mechanism.

The second-type encoding unit 43a2 is a component that applies a predefined second-type encoding to the second-type data in the first output data, generating corresponding second-type output data verification information. In this embodiment, “second-type encoding” refers to the encoding method used by the second data verification mechanism.

The bus bridge provided in the present application selectively applies the more complex, error-correcting second-type encoding only to critical data. This ensures better correctness and integrity for crucial data while avoiding excessive consumption of computational resources and data transmission bandwidth.

For example, the first-type verification unit 42a1 includes two fundamental functional units: a first-type encoder 42a11 and a first-type comparator 42a12.

The first-type encoder 42a11 is a component designed to perform first-type encoding. It applies the predefined first-type encoding to the first-type data in the received data, producing a corresponding first-type encoded result.

The first-type comparator 42a12 is a component that detects discrepancies between data. It compares the first-type verification information with the first-type encoded result to determine whether they match.

As explained earlier, provided that the first-type verification information is generated using the same first-type encoding, if no errors occur in the first-type data during bus transmission, the first-type encoded result from the first-type encoder 42a11 should align with the first-type verification information. Conversely, if errors arise in the first-type data during transmission, discrepancies between the verification information and the encoded result will emerge.

Thus, when the first-type comparator 42a12 detects inconsistency between the first-type verification information and the encoded result, it outputs a verification result indicating errors in the first-type data of the received data.

Continuing with FIG. 7, the error detection subunit 42a21 may include: a second-type encoder 42a211 and a second-type comparator 42a212.

The second-type encoder 42a211 is a component designed to perform second-type encoding. It applies the second-type encoding to the second-type data in the first received data, generating a corresponding second-type encoded result.

The second-type comparator 42a212 is a component that detects discrepancies between data. It is termed “second-type” to distinguish it from the first-type comparator, as it compares the second-type verification information with the second-type encoded result.

Based on principles similar to those above, provided that the second-type verification information is generated using the same second-type encoding, if no errors occur in the second-type data during bus transmission, the second-type encoded result from the second-type encoder 42a211 should align with the second-type verification information. Conversely, if errors arise in the second-type data during transmission, discrepancies between the verification information and the encoded result will emerge.

Thus, when the second-type comparator 42a212 determines inconsistency between the second-type verification information and the second-type encoded result, it outputs a corresponding verification result, indicating errors in the second-type data of the received data.

Further, referring to FIG. 7, leveraging the error correction capability of second-type encoding, when the second-type comparator 42a212 identifies errors in the second-type data, the error correction subunit 42a22 may first utilize redundant second-type verification information to attempt correcting and recovering the errors, then provide feedback on whether the correction and recovery were successful.

The technical features of the bus bridge described in the above embodiments can be combined in various ways to create additional implementations. For example, building on the design of dividing received data into two parts, each data buffer unit may further split into a content buffer subunit and an instruction buffer subunit, dedicated to buffering content data and instruction data within the received data, respectively.

In the present application, content data and instruction data are classifications of received data based on their functional roles. “Content data” refers to the actual data information in the received data, typically representing information or states (e.g., sensor readings, file contents, or user inputs). “Instruction data” refers to command information that controls system or device behavior, guiding how content data is processed or specific tasks are executed.

For example, the classification of received data into first-type and second-type data may align with the categorization of content and instruction data. For instance, content data may be designated as second-type data, while instruction data may serve as first-type data.

A subset of critical content data may be classified as second-type data, with the remaining content data and all instruction data treated as first-type data.

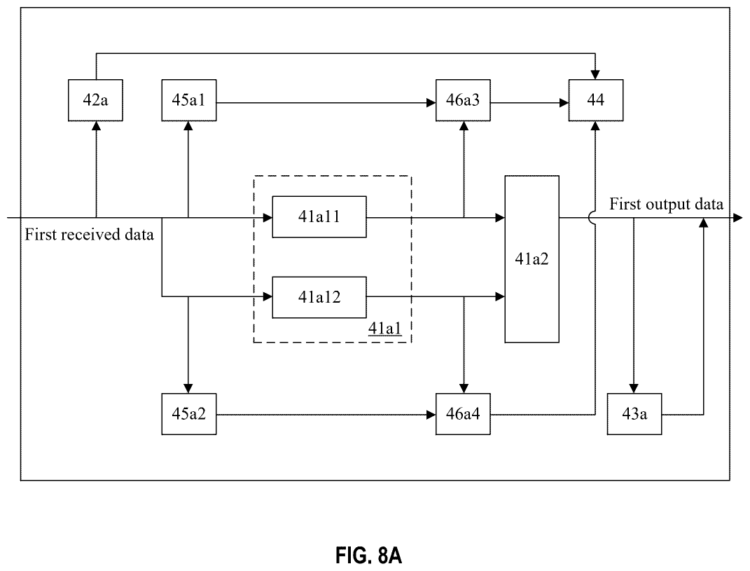

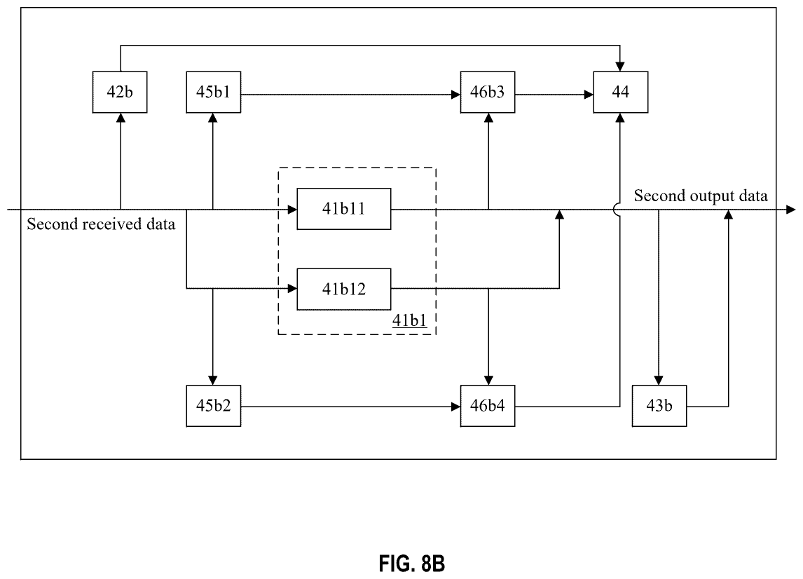

As an example, FIG. 8A illustrates that the content buffer subunit and instruction buffer subunit formed by the first data buffer unit 41a1 may be termed the “first content buffer subunit 41a11” and “first instruction buffer subunit 41a12,” respectively. The content data and instruction data in the first received data are referred to as “first content” and “first instruction.”

The first content buffer subunit 41a11 controls the orderly entry and exit of first content using a predefined data management mechanism (e.g., the aforementioned FIFO mechanism), enabling temporary storage of first content. Similarly, the first instruction buffer subunit 41a12 applies the same mechanism to manage the orderly entry and exit of each first instruction for temporary storage.

As shown in FIG. 8B, the content buffer subunit and instruction buffer subunit formed by the second data buffer unit 41b1 may be termed the “second content buffer subunit 41b11” and “second instruction buffer subunit 41b12,” respectively, buffering the content data and instruction data in the second received data. The content and instruction data in the second received data are termed “second content” and “second instruction.”

The second content buffer subunit 41b11 controls the orderly entry and exit of second content using the predefined data management mechanism (e.g., FIFO), while the second instruction buffer subunit 41b12 applies the same mechanism to manage the orderly entry and exit of each second instruction.

In other embodiments, aligning with the division of each data buffer unit into content and instruction buffer subunits, the buffer encoding and verification modules may also be split into corresponding submodules for data verification during the buffering of content and instruction data.

The buffer encoding module includes: a content buffer encoding submodule and an instruction buffer encoding submodule. The content buffer encoding submodule encodes content data before it enters the content buffer subunit, generating corresponding content verification information. The instruction buffer encoding submodule encodes instruction data before it enters the instruction buffer subunit, generating corresponding instruction verification information.

The buffer verification module includes: a content buffer verification submodule and an instruction buffer verification submodule. These submodules determine the verification results for content data exiting the content buffer subunit based on content verification information, and for instruction data exiting the instruction buffer subunit based on instruction verification information, respectively.

For example, referring FIG. 8A, the content buffer encoding submodule and instruction buffer encoding submodule of the first buffer encoding module 45a may be termed the “first content buffer encoding submodule 45a1” and “first instruction buffer encoding submodule 45a2.” Similarly, the content buffer verification submodule and instruction buffer verification submodule of the first buffer verification module 46a may be termed the “first content buffer verification submodule 46a3” and “first instruction buffer verification submodule 46a4.”

Similarly, referring to FIG. 8B, when the second data buffer unit 41b1 also includes content and instruction buffer subunits, the second buffer encoding module 45b forms a content buffer encoding submodule and an instruction buffer encoding submodule, while the second buffer verification module 46b forms a content buffer verification submodule and an instruction buffer verification submodule.

The content buffer encoding submodule and instruction buffer encoding submodule of the second buffer encoding module 45b may be termed the “second content buffer encoding submodule 45b1” and “second instruction buffer encoding submodule 45b2,” respectively. The content buffer verification submodule and instruction buffer verification submodule of the second buffer verification module 46b may be termed the “second content buffer verification submodule 46b3” and “second instruction buffer verification submodule 46b4,” respectively.

In some embodiments, given the relatively low likelihood of errors during data buffering, the buffer encoding and verification modules may adopt a first verification mechanism based on a first encoding type, which only provides error detection capabilities. This reduces computational resource consumption and redundant information.

To integrate verification results from one or more implemented data verification mechanisms and efficiently report data verification outcomes during transmission, the bus bridge may further include a functional safety management module 44 for collecting and consolidating verification results, as illustrated in FIGS. 8A and 8B.

The “verification results” determined or output by the verification modules can generally be categorized into two types: data with errors and data without errors. These are termed “verification failure information” and “verification success information,” respectively.

The functional safety management module 44 communicates with all verification modules (i.e., the first received data verification module, second received data verification module, first buffer verification module, and second buffer verification module) and receives verification failure information generated by these modules. In other words, any verification failure information produced by a verification module is collected into the functional safety management module 44.

Additionally, the functional safety management module 44 may predefine specific logical judgment rules to filter and process all collected verification failure information. This generates corresponding error reporting instructions for higher-level systems or devices, enabling timely detection of data errors during transmission through the bus bridge and facilitating appropriate responses to prevent safety incidents.

The specific form of the error reporting instruction can be configured by technical personnel based on practical needs and is not strictly limited herein. For example, it could be an IRQ (Interrupt Request) or FIQ (Fast Interrupt Request) signal.

As detailed in previous embodiments, the verification failure information generated by all verification modules may include: first verification failure information indicating errors in first-type received data; second verification failure information indicating errors in second-type received data; third verification failure information indicating errors in first received data after exiting the first data buffer unit; and fourth verification failure information indicating errors in second received data after exiting the second data buffer unit.

Depending on practical requirements, the first to fourth verification failure information may be assigned corresponding reporting priorities. The functional safety management module 44 can then filter all received verification failure information based on these priorities to generate appropriate error reporting instructions.

For instance, the second verification failure information may be assigned a lower priority than the first verification failure information, allowing the functional safety management module 44 to wait for error correction results of the second-type received data before deciding whether to trigger an interrupt signal.

Alternatively, the third and fourth verification failure information may be assigned lower priorities than the first verification failure information. This enables the module to generate slower-response IRQ signals instead of fast-response FIQ signals when errors occur solely during data buffering.

To further illustrate the implementation of the present application, the specific workflow of the bus bridge is described using an example of a bridge between an APB (Advanced Peripheral Bus) and an AHB (Advanced High-performance Bus).

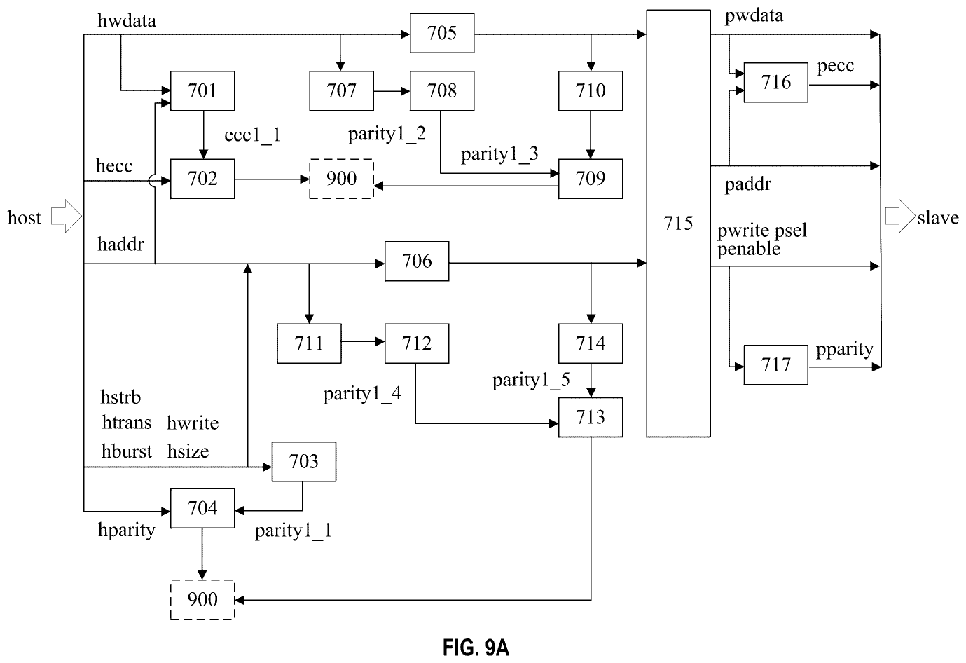

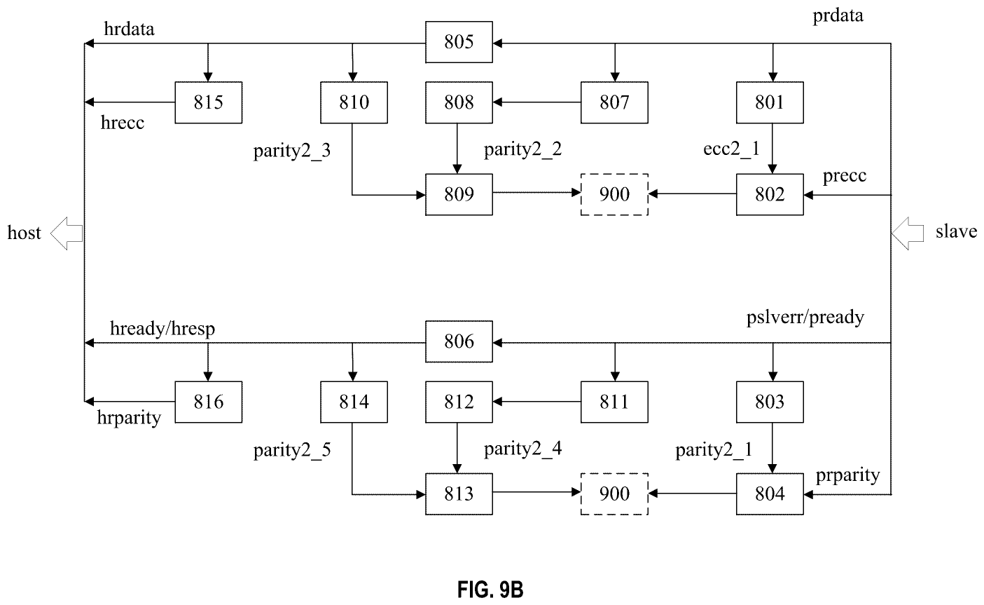

FIGS. 9A and 9B depict a scenario where the bus bridge connects communication systems based on APB and AHB buses. A host in the AHB-based system (e.g., an ARM processor core) can communicate bidirectionally with slaves in the APB-based system (e.g., a serial communication interface or analog-to-digital converter) through the bus bridge.

(1) Specific Working Process of the Bus Bridge When the Host Sends Commands to the Slave

The command sent by the host is the first data complying with the AHB bus transmission protocol. As shown in FIG. 9A, this first data may consist of the following series of commands: hwrite indicating a write operation, htrans indicating data transfer type, hburst indicating data transfer burst type, hsize indicating data width, hstrb indicating valid bytes in data, haddr indicating data transfer address, hwdata indicating write data content, hparity indicating parity check results, and hecc indicating ECC encoding results.

(1.1) Data Verification Process Based on ECC Encoding

First, the haddr command indicating the data transfer address and the hwdata command indicating the write data content are fed into the ECC decoding unit 701. The ECC decoding unit 701 performs splicing followed by ECC encoding to obtain the corresponding ECC encoding result ecc1_1.

Then, the ECC encoding result ecc1_1 obtained by the ECC decoding unit 701 is provided to the comparator 702, while the hecc command carried in the first data is also provided to the comparator 702. Based on the comparison between the hecc command and the ECC encoding result ecc1_1, the comparator 702 performs error detection and correction on the haddr command and hwdata content, and delivers the corresponding verification results to the functional safety management module 900.

### (1.2) Data Verification Process Based on Parity Check

First, the hwrite command indicating write operations, htrans command indicating data transfer types, hburst command indicating data transfer burst types, hsize command indicating data width, and hstrb command indicating valid bytes are fed into the parity check calculation unit 703. The parity check calculation unit 703 performs splicing followed by parity check calculation to obtain the corresponding parity check result parity1_1.

Then, the parity check result parity1_1 obtained by the parity check calculation unit 703 is provided to the comparator 704, while the hparity command carried in the first data is also provided to the comparator 704. Based on the comparison between the hparity command and the parity check result parity1_1, the comparator 704 performs error detection on the hwrite, htrans, hburst, hsize, and hstrb commands, and delivers the data verification results to the functional safety management module 900.

### (1.3) Data Buffering Process

The bus bridge uses two relatively independent data buffering units, referred to as the content data buffer unit 705 and the command data buffer unit 706.

On one hand, the hwdata command indicating write data content is provided to the content data buffer unit 705. The content data buffer unit 705 implements data buffering using a “First-In-First-Out” (FIFO) data management mechanism.

On the other hand, the hwrite command indicating write operations, htrans command indicating data transfer types, hburst command indicating data transfer burst types, hsize command indicating data width, hstrb command indicating valid bytes, and haddr command indicating data transfer addresses are provided to the command data buffer unit 706. The command data buffer unit 706 also employs a “First-In-First-Out” (FIFO) data management mechanism for data buffering.

### (1.4) Data Verification During Buffering

Based on the two independent content data buffer unit 705 and command data buffer unit 706, the data verification during buffering can be divided into two parts:

### For the Content Data Buffer Unit 705

First, before entering the content data buffer unit 705, the hwdata command is also provided to the parity check calculation unit 707 for parity check calculation, obtaining parity check result parity1_2. This parity1_2 is delivered to comparator 709 through verification data buffer unit 708.

Subsequently, the hwdata content exiting the content data buffer unit 705 is provided to another parity check calculation unit 710 for parity check calculation, obtaining parity check result parity1_3. This parity1_3 is also delivered to comparator 709.

Finally, the comparator 709 performs error detection on the hwdata content based on the comparison between parity1_2 and parity1_3, and delivers the verification result (whether errors occurred in hwdata exiting the content data buffer unit) to the functional safety management module 900.

### For the Command Data Buffer Unit 706

First, before entering the command data buffer unit 706, the hwrite, htrans, hburst, hsize, hstrb, and haddr commands are provided to the parity check calculation unit 711. The parity check calculation unit 711 performs splicing followed by parity check calculation to obtain parity check result parity1_4. This parity1_4 is delivered to comparator 713 through another verification data buffer unit 712.

Subsequently, the hwrite, htrans, hburst, hsize, hstrb, and haddr commands exiting the command data buffer unit 706 are provided to another parity check calculation unit 714. The parity check calculation unit 714 performs splicing followed by parity check calculation to obtain parity check result parity1_5. This parity1_5 is also delivered to comparator 713.

Finally, the comparator 713 performs error detection based on the comparison between parity1_4 and parity1_5, and delivers the verification results to the functional safety management module 900.

### (1.5) Protocol Packaging Process

Through temporary storage of data content in the content data buffer unit 705 and temporary storage of commands in the command data buffer unit 706, transmission rate matching between data content and commands is achieved. This ensures that the same received data content hwdata, commands hwrite, htrans, hburst, hsize, hstrb, and haddr can be simultaneously fed into the protocol packaging unit 715 for one or multiple data processing operations (e.g., adding necessary header information, control characters, etc.), thereby generating second data complying with the APB bus transmission protocol.

The second data may consist of the following commands: pwdata indicating transferred data content, paddr indicating transfer addresses, psel indicating the target slave for data transfer, penable indicating transfer enable status, and pwrite indicating write operations.

For the second data formed by the protocol packaging unit 715, the relatively critical information-carrying data content pwdata and command paddr are further provided to the ECC encoding unit 716. After being spliced and encoded by the ECC encoding unit 716, the corresponding ECC encoding result is obtained. This result is labeled as the pecc command, serving as part of the verification information accompanying the second data output.

The remaining commands psel, penable, and pwrite in the second data are provided to the parity check calculation unit 717. After being spliced and calculated by the parity check calculation unit 717, the corresponding parity check result is obtained. This result is labeled as the pparity command, serving as part of the verification information accompanying the second data output.

Thus, the second data carrying verification information (pecc and pparity commands) can reach the specific target slave through the APB bus-based communication system.

### (2) Specific Working Process of the Bus Bridge When the Slave Provides Feedback to the Host

The slave's feedback data is third data complying with the APB bus transmission protocol. As shown in FIG. 9B, this third data may consist of the following commands: prdata indicating data content read from the slave, pready indicating whether the slave is ready for data transfer, pslverr indicating whether the slave has encountered errors, precc indicating ECC encoding results, and prparity indicating parity check calculation results.

### (2.1) Data Verification Process Based on ECC Encoding

First, the prdata command indicating data content read from the slave is fed into the ECC decoding unit 801, where ECC encoding is performed to obtain the corresponding ECC encoding result ecc2_1.

Next, while the ECC encoding result ecc2_1 obtained by the ECC decoding unit 801 is provided to comparator 802, the precc command carried in the third data is also provided to comparator 802. Based on the comparison between ecc2_1 and the precc command, comparator 802 performs error detection and correction on the prdata content, and delivers the verification results to the functional safety management module 900.

### (2.2) Data Verification Process Based on Parity Check

First, the pready command indicating slave readiness and the pslverr command indicating slave errors are fed into the parity check calculation unit 803. The parity check calculation unit 803 performs splicing followed by parity check calculation to obtain the parity check result parity2_1.

Next, while the parity2_1 result obtained by the parity check calculation unit 803 is provided to comparator 804, the prparity command carried in the third data is also provided to comparator 804. Based on the comparison between parity2_1 and the prparity command, comparator 804 performs error detection on the pready and pslverr commands, and delivers the verification results to the functional safety management module 900.

### (2.3) Data Buffering Process

The bus bridge uses two independent units—content data buffer unit 805 and command data buffer unit 806—to buffer different parts of the third data.

On one hand, the prdata command indicating data content read from the slave is provided to the content data buffer unit 805. The content data buffer unit 805 implements data buffering using a “First-In-First-Out” (FIFO) data management mechanism.

On the other hand, the pready command indicating slave readiness and pslverr command indicating slave errors are provided to the command data buffer unit 806. The command data buffer unit 806 also employs a “First-In-First-Out” (FIFO) data management mechanism for data buffering.

### (2.4) Data Verification During Buffering

Based on these two independent units (content data buffer unit 805 and command data buffer unit 806), the data verification during buffering is divided into two parts:

### For the Content Data Buffer Unit 805

First, before entering the content data buffer unit 805, the prdata content is provided to parity check calculation unit 807 for parity check calculation, obtaining parity check result parity2_2. This parity2_2 is delivered to comparator 809 through verification data buffer unit 808.

Subsequently, the prdata content exiting the content data buffer unit 805 is provided to another parity check calculation unit 810 for parity check calculation, obtaining parity check result parity2_3. This parity2_3 is also delivered to comparator 809.

Finally, comparator 809 performs error detection on the prdata content based on the comparison between parity2_2 and parity2_3, and delivers the verification results to the functional safety management module 900.

### For the Command Data Buffer Unit 806

First, before entering the command data buffer unit 806, the pready and pslverr commands are provided to parity check calculation unit 811. The parity check calculation unit 811 performs splicing followed by parity check calculation to obtain parity check result parity2_4. This parity2_4 is delivered to comparator 813 through another verification data buffer unit 812.

Subsequently, the pready and pslverr commands exiting the command data buffer unit 806 are provided to another parity check calculation unit 814. The parity check calculation unit 814 performs splicing followed by parity check calculation to obtain parity check result parity2_5. This parity2_5 is also delivered to comparator 813.

Finally, comparator 813 performs error detection based on the comparison between parity2_4 and parity2_5, and delivers the verification results to the functional safety management module 900.

### (2.5) Verification Information Generation Process

The prdata content exiting the content data buffer unit 805 is converted into hrdata complying with the AHB bus protocol. The hrdata is further provided to ECC encoding unit 815. After splicing and encoding by unit 815, the corresponding ECC encoding result is obtained. This result is labeled as the hrecc command, serving as part of the verification information.

The pready and pslverr commands exiting the command data buffer unit 806 are converted into hresp and hready commands complying with the AHB bus protocol. These commands are provided to parity check calculation unit 816. After splicing and calculation by the parity check calculation unit 816, the corresponding parity check result is obtained. This result is labeled as hrparity, serving as another part of the verification information.

Thus, the fourth data converted by the bus bridge—complying with the AHB bus protocol and carrying verification information—can reach the corresponding host through the AHB bus-based communication system.

### (3) Processing by Functional Safety Management Module

As described above, the functional safety management module 900 may receive verification results from multiple comparators. The functional safety management module 900 can apply any suitable decision rules based on actual requirements to logically evaluate these results and generate corresponding exception commands (e.g., interrupt signals), enabling the chip to actively and promptly respond to data transmission errors.

For example, the functional safety management module 900 may adopt a “one-vote veto” judgement rule: if any comparator fails verification, it directly marks an error and provides an interrupt signal, triggering measures such as stopping the corresponding slave's operation and distrusting data from that slave.

The functional safety management module 900 may use a “graded marking” rule. Based on different severity levels of verification failures from various comparators, it marks specific portions of data as erroneous while maintaining basic system operation.

Finally, it should be noted: For illustrative purposes, FIGS. 9A and 9B show multiple units with identical functional names. Those skilled in the art will understand that units sharing functional names may be implemented either as integrated components or distributed across multiple independent modules.

The above embodiments merely illustrate the technical solutions of the present application without limiting them. Under the concepts of the present application, technical features from different embodiments may be combined, steps may be implemented in any order, and numerous other variations exist as described. For brevity, detailed descriptions are omitted. Although described in detail with reference to preceding embodiments, those skilled in the art should understand: modifications to the technical solutions or equivalent replacements of partial technical features may still be made without departing from the essence of the technical solutions within the scope of the present application.

What is claimed is:

1. A bus bridge, comprising:
a received data verification module, configured to determine a reception verification result of a received data based on a received data verification information carried by the received data;
a data protocol conversion module, configured to convert the received data conforming to an initial data transmission specification into an output data conforming to a target data transmission specification;
an output data encoding module, configured to encode at least a portion of the output data to generate a corresponding output data verification information, thereby enabling the output data to carry the corresponding output data verification information; and
a functional safety management module, configured to process the reception verification result provided by the received data verification module according to preset rules to generate a corresponding error reporting instruction.

2. The bus bridge according to claim 1, wherein
the bus bridge is bridged between a first bus and a second bus;
the first bus and the second bus have different data transmission specifications; and
the data protocol conversion module forms a first conversion path and a second conversion path, wherein
the first conversion path is configured to convert a first received data from the first bus into a first output data conforming to the data transmission specification of the second bus; and
the second conversion path is configured to convert a second received data from the second bus into a second output data conforming to the data transmission specification of the first bus.

3. The bus bridge according to claim 2,
wherein the received data verification module comprises: a first received data verification module disposed on the first conversion path and a second received data verification module disposed on the second conversion path, wherein
the first received data verification module is configured to determine a first reception verification result of the first received data based on a first received data verification information carried by the first received data; and
the second received data verification module is configured to determine a second reception verification result of the second received data based on a second received data verification information carried by the second received data,
wherein the output data encoding module comprises: a first output data encoding module disposed on the first conversion path and a second output data encoding module disposed on the second conversion path, wherein
the first output data encoding module is configured to encode at least a portion of the first output data to generate corresponding first output data verification information, thereby enabling the first output data to carry the corresponding first output data verification information; and
the second output data encoding module is configured to encode at least a portion of the second output data to generate corresponding second output data verification information, thereby enabling the second output data to carry the corresponding second output data verification information.

4. The bus bridge according to claim 1, wherein
the received data comprises first-type received data and second-type received data; the received data verification information comprises first-type received data verification information and second-type received data verification information; and
the received data verification module comprises:
a first-type verification unit configured to determine whether the first-type received data contains errors based on the first-type received data verification information;
a second-type verification unit including an error detection subunit and an error correction subunit;
the error detection subunit is configured to determine whether the second-type received data contains errors based on the second-type received data verification information; and
the error correction subunit is configured to correct the second-type received data using the second-type received data verification information in response to the second-type received data containing errors.

5. The bus bridge according to claim 4, wherein the first-type verification unit comprises:
a first-type encoder configured to perform a preset first-type encoding on the first-type received data to obtain a corresponding first-type encoding result; and
a first-type comparator configured to compare the first-type received data verification information with the first-type encoding result, and determine that the first-type received data contains errors in response to inconsistency between the first-type received data verification information and the first-type encoding result.

6. The bus bridge according to claim 4, wherein the error detection subunit comprises:
a second-type encoder configured to perform a preset second-type encoding on the second-type received data to obtain a corresponding second-type encoding result; and
a second-type comparator configured to determine that the second-type received data contains errors in response to inconsistency between the second-type received data verification information and the second-type encoding result.

7. The bus bridge according to claim 4, wherein the reception verification result comprises first verification failure information indicating errors in the first-type received data and second verification failure information indicating errors in the second-type received data;
the functional safety management module is configured to receive the first verification failure information and the second verification failure information; and
determine priorities of the first verification failure information and the second verification failure information according to preset rules to generate the error reporting instruction.

8. The bus bridge according to claim 1, wherein
the output data comprises first-type output data and second-type output data;
the output data verification information comprises first-type output data verification information and second-type output data verification information; and
the output data encoding module comprises:
a first-type encoding unit configured to perform preset first-type encoding on the first-type output data to generate corresponding first-type output data verification information; and
a second-type encoding unit configured to perform preset second-type encoding on the second-type output data to generate corresponding second-type output data verification information.

9. The bus bridge according to claim 2, wherein at least one of the first conversion path and the second conversion path is provided with a data buffer unit; and
the data buffer unit is configured to control each piece of received data to orderly enter and exit the data buffer unit according to a preset data management mechanism.

10. The bus bridge according to claim 9, further comprising:
a cache encoding module configured to encode the received data before entering the data buffer unit to generate corresponding cache verification information; and
a cache verification module configured to determine a cache verification result of the received data after exiting the data buffer unit based on the cache verification information.

11. The bus bridge according to claim 10, wherein the data buffer unit comprises:
a first data buffer unit disposed on the first conversion path, configured to control each piece of the first received data to orderly enter and exit the first data buffer unit according to the data management mechanism; and
a second data buffer unit disposed on the second conversion path, configured to control each piece of the second received data to orderly enter and exit the second data buffer unit according to the data management mechanism;
the cache encoding module comprises:
a first cache encoding module configured to encode the first received data before entering the first data buffer unit to generate corresponding first cache verification information; and
a second cache encoding module configured to encode the second received data before entering the second data buffer unit to generate corresponding second cache verification information;
the cache verification module comprises:
a first cache verification module configured to determine a cache verification result of the first received data after exiting the first data buffer unit based on the first cache verification information; and
a second cache verification module configured to determine a cache verification result of the second received data after exiting the second data buffer unit based on the second cache verification information.

12. The bus bridge according to claim 10, wherein the received data comprises content data and command data; and
the data buffer unit comprises:
a content buffer subunit configured to control content data in each piece of received data to orderly enter and exit the content buffer subunit according to a preset data management mechanism; and
a command buffer subunit configured to control command data in each piece of received data to orderly enter and exit the command buffer subunit according to a preset data management mechanism.

13. The bus bridge according to claim 12, wherein the cache encoding module comprises:
a content cache encoding subunit configured to encode the content data before entering the content buffer subunit to generate corresponding content verification information; and
a command cache encoding subunit configured to encode the command data before entering the command buffer subunit to generate corresponding command verification information;
the cache verification module comprises:
a content cache verification subunit configured to determine a cache verification result of the content data after exiting the content buffer subunit based on the content verification information; and
a command cache verification subunit configured to determine a cache verification result of the command data after exiting the command buffer subunit based on the command verification information.

14. The bus bridge according to claim 10, wherein the cache verification module comprises:
a verification information buffer unit configured to control each piece of cache verification information generated by the cache encoding module to orderly enter and exit the verification information buffer unit according to a preset data management mechanism;
a verification information encoder configured to encode the received data after exiting the data buffer unit to obtain a corresponding encoding result;
a verification information comparator configured to compare the cache verification information exiting the verification information buffer unit with the encoding result; and
determine that the received data after exiting the data buffer unit contains errors in response to inconsistency between the cache verification information and the encoding result.

15. The bus bridge according to claim 10, wherein the functional safety management module is configured to:
receive the reception verification result from the received data verification module and the cache verification result from the cache verification module; and
determine priorities of the reception verification result and the cache verification result according to preset rules to generate the error reporting instruction.

16. The bus bridge according to claim 2, wherein at least one of the first conversion path and the second conversion path further comprises a protocol packaging unit,
wherein the protocol packaging unit is configured to perform data encapsulation processing on the received data according to the target data transmission specification to form the output data.

17. A chip, comprising:
at least one first device, connected to a first bus;
at least one second device, connected to a second bus; and
a bus bridge, bridged between the first bus and the second bus to establish a communication connection between the at least one first device and the at least one second device,
wherein the bus bridge, comprising:
a received data verification module, configured to determine a reception verification result of a received data based on a received data verification information carried by the received data;
a data protocol conversion module, configured to convert the received data conforming to an initial data transmission specification into an output data conforming to a target data transmission specification;
an output data encoding module, configured to encode at least a portion of the output data to generate a corresponding output data verification information, thereby enabling the output data to carry the corresponding output data verification information; and
a functional safety management module, configured to process the reception verification result provided by the received data verification module according to preset rules to generate a corresponding error reporting instruction.

18. A LiDAR, comprising a chip,
wherein the chip comprises:
at least one first device, connected to a first bus;
at least one second device, connected to a second bus; and
a bus bridge, bridged between the first bus and the second bus to establish a communication connection between the at least one first device and the at least one second device,
wherein the bus bridge comprises:
a received data verification module, configured to determine a reception verification result of a received data based on a received data verification information carried by the received data;
a data protocol conversion module, configured to convert the received data conforming to an initial data transmission specification into an output data conforming to a target data transmission specification;
an output data encoding module, configured to encode at least a portion of the output data to generate a corresponding output data verification information, thereby enabling the output data to carry the corresponding output data verification information; and
a functional safety management module, configured to process the reception verification result provided by the received data verification module according to preset rules to generate a corresponding error reporting instruction.
